(19) United States
(12) Patent Application Publication
(10) Pub. No.: US 2015/0211686 A1
(43) Pub. Date: Jul. 30, 2015

(54) METHOD AND APPARATUS FOR ABANDONING OR ISOLATING AN UNDERGROUND PIPELINE

(71) Applicant: Clarence DYCK, Medicine Hat (CA)

(72) Inventor: Clarence DYCK, Medicine Hat (CA)

(21) Appl. No.: 14/608,269

(22) Filed: Jan. 29, 2015

Related U.S. Application Data
(60) Provisional application No. 61/933,637, filed on Jan. 30, 2014.

(30) Foreign Application Priority Data
Jun. 26, 2014 (CA) 2855381

(51) Int. Cl. F17D 5/02; F16L 55/11

(52) U.S. Cl. CPC F17D 5/02; F16L 55/1141

(57) ABSTRACT

There is provided a method of abandoning or isolating a section of a pipeline. The method has the steps of exposing the section of the pipeline, hot tapping the section of the pipeline to form an opening while maintaining the pressure in the section of the pipeline, injecting a formable plugging material through the opening to form a sealing plug in the section of the pipeline, and releasing the pressure in the section of the pipeline.

### TECHNICAL FIELD

This relates to a method and apparatus for abandoning or isolating an underground pipeline under normal operating pressures.

### BACKGROUND

Pipeline networks are installed in order to transport fluids produced from wells to a central location, such as for transportation or processing. Once a well is no longer producing, the pipelines may need to be abandoned. There may be other reasons for isolating or abandoning a pipeline. Pipeline abandonment or isolation can be an intensive process, often requiring excavation by heavy equipment, extensive depressurization processes, and welding. As the pipeline will generally be pressurized with volatile compounds, time and care must be taken, which increases the time and cost requirements.

### SUMMARY

According to an aspect, there is provided a method of abandoning or isolating a section of a pipeline. The method comprises the steps of exposing the section of the pipeline to be abandoned, hot tapping the section of the pipeline to form an opening while maintaining the pressure in the section of the pipeline, injecting a formable plugging material through the opening to form a sealing plug in the section of the pipeline, and releasing the pressure in the section of the pipeline.

According to another aspect, the plugging material may be an epoxy, a resin, or a polymer.

According to another aspect, the method may further comprise the step of forming an anchor in the pipeline that engages the plug to support the plug within the section of the pipeline.

According to another aspect, forming an anchor may comprise deforming the pipeline inward while forming an opening during hot tapping.

According to another aspect, forming an anchor may comprise crimping the pipeline on the sealing plug to enhance the seal of the sealing plug.

According to another aspect, the method may further comprise the step of inserting a cleaning nozzle to clean the pipeline internally.

According to another aspect, the method may further comprise the step of injecting an inert gas to pressure test and clear debris prior to injecting the formable plugging material.

According to another aspect, the pipeline may have one of a 2 inch diameter, a 3 inch diameter, and a 4 inch diameter.

According to another aspect, the plug may maintain up to a 450 psi pressure differential between a production side and an abandoned side.

According to an aspect, there is provided a combination of a hot tapping tool adapted to hot tap a section of a pipeline to form an opening while maintaining the pressure in the section of the pipeline, and an injector adapted to inject a formable plugging material through the opening to form a sealing plug in the section of the pipeline.

According to another aspect, the plugging material may be an epoxy, a resin, or a polymer.

According to another aspect, there may be a camera for determining the degree of cleaning required in the pipeline.

According to another aspect, there may be a jet nozzle for cleaning the pipeline internally.

According to another aspect, there may be a source of inert gas connected to pressurize the hot tapping tool.

According to another aspect, the pipeline may have one of a 2 inch diameter, a 3 inch diameter, and a 4 inch diameter.

According to another aspect, there may be a tool for deforming the pipeline to form an anchor for anchoring the plug within the pipeline.

According to another aspect, there may be a source of formable plugging material connected to the injector.

According to another aspect, there may be a tool to cut a segment from an abandoned section of a pipeline for terminating and detaching the abandoned section of the pipeline from a remaining section of the pipeline.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a representative schematic of a pipeline to be abandoned.

FIG. 2 is an alternative representative schematic of a pipeline to be abandoned.

FIG. 3 is a perspective view of a tool for abandoning a pipeline.

FIG. 4 is a perspective of the modified split tee.

FIG. 5 is a side elevation view of a tool being inserted into the pipeline.

FIG. 6 is a side elevation view in section of a nozzle for breaching the sidewall of the pipeline.

FIG. 7 is a side elevation view in section of a piston and cylinder.

FIG. 8 is a perspective view of a hydraulic press attachment.

FIG. 9 is a side elevation view of a camera being inserted into the pipeline.

FIG. 10 is a side elevation view of a nozzle being inserted into the pipeline.

### DETAILED DESCRIPTION

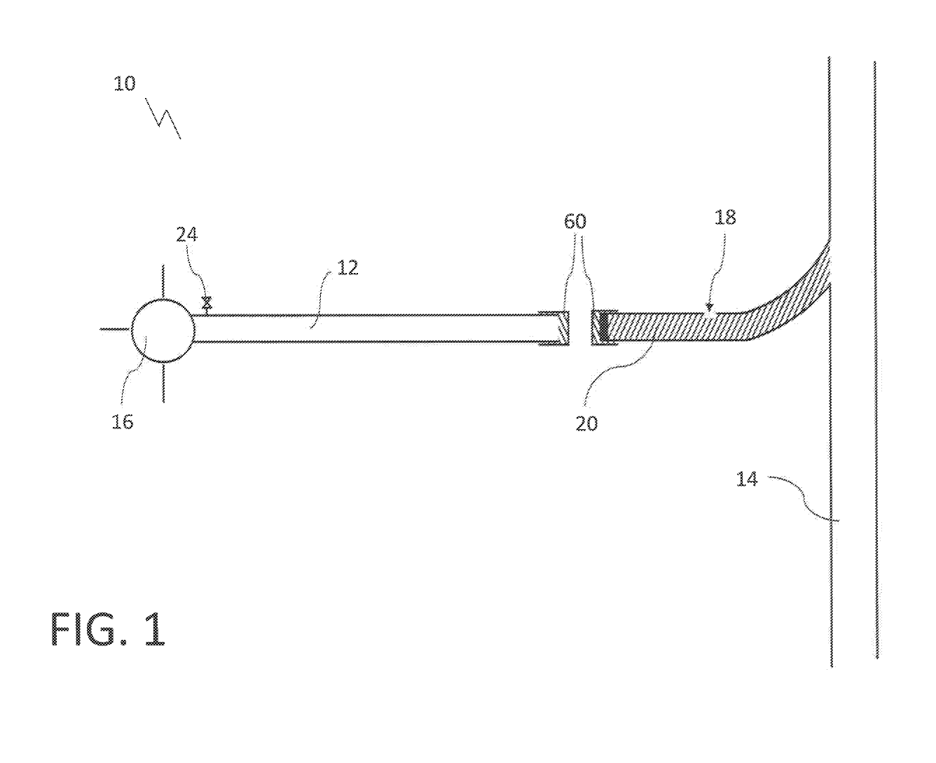

A method and apparatus for abandoning or isolating a section of pipeline will now be described with reference to FIG. 1 through 10. While the discussion below is in terms of a section to be abandoned, it will be understood that similar tools and steps may be used with respect to a section to be isolated.

Referring to FIG. 1, a pipeline 10 is shown that has a section 12 to be abandoned, and a remaining portion 14. The abandoned portion 12 connects to a source 16 of material to be transported in pipeline 10. Source 16 may be, for example, an oil or gas well that is no longer producing or that is being produced into a separate container. Pipeline 10 may be, for example, a buried pipeline intended to transport natural gas from a producing well and may be transporting the natural gas to a refinery or processing plant. Generally, this type of pipeline is a 2 inch pipeline, although other sizes may also be used in rare circumstances, such as a 3 inch pipeline. The method described herein may also be applied to other types of pipelines that are being abandoned.

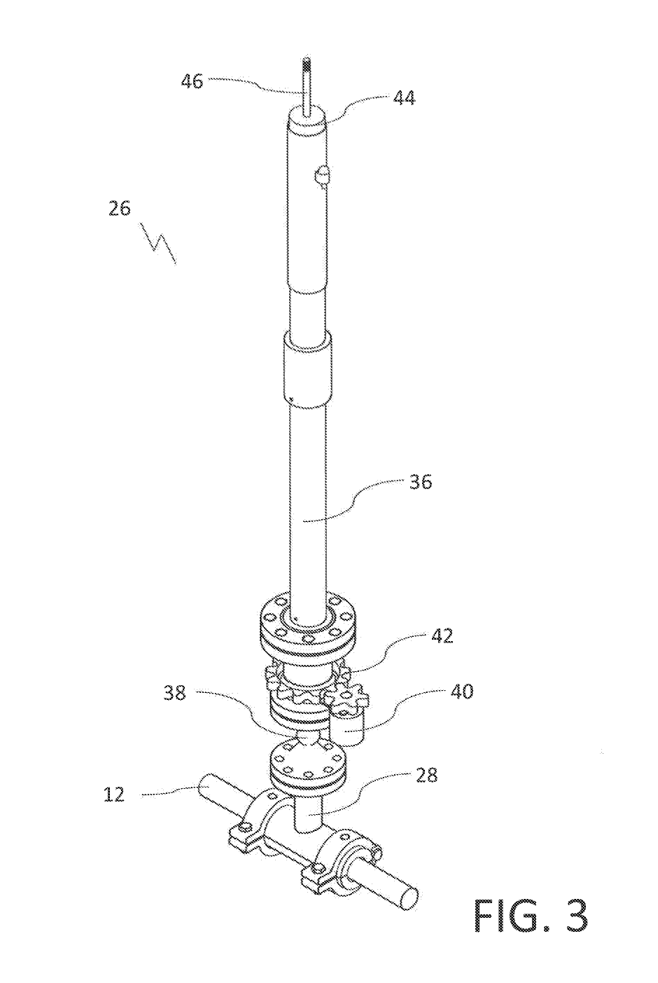

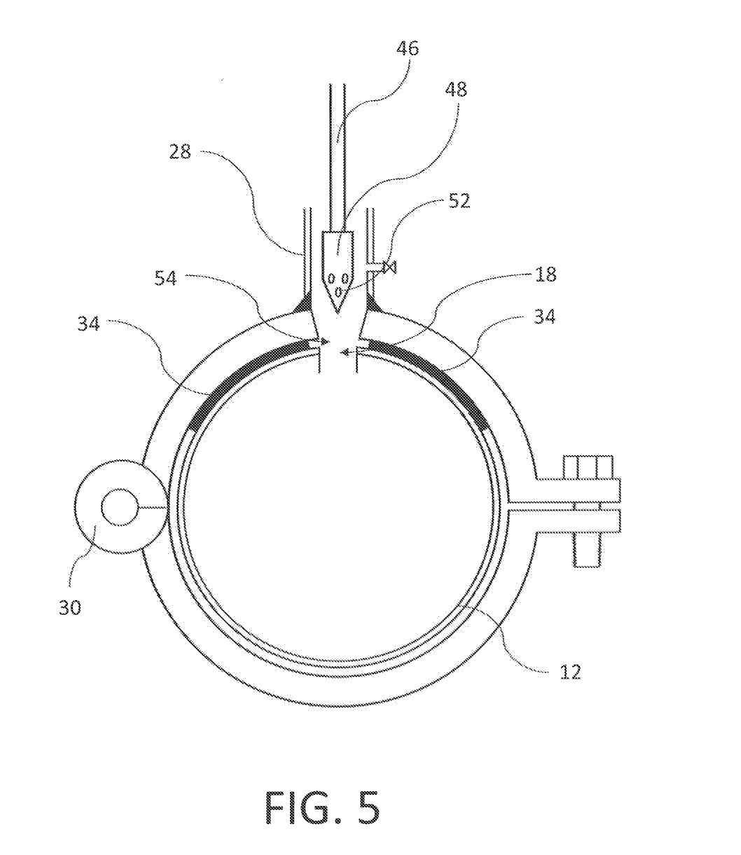

Referring to FIG. 3, a hot tapping tool, generally indicated by reference number 26, is first attached to pipeline section 12 at the point where the seal or plug is to be initiated. In order to hot tap pipeline section 12, hot tapping tool 26 provides a seal against pipeline section 12 and creates a sealed working space between pipeline section 12 and hot tapping tool 26. As is known in the industry, hot tapping tool 26 must be designed to withstand the pressures and fluids within pipeline section 12 as it will be exposed to these pressures and fluids. While a particular hot tapping tool is shown in the drawings and described in greater detail below, it will be understood that other designs for hot tapping tools may equally be used. Referring to FIG. 5, once properly installed, hot tapping tool 26 creates an opening 18 in pipeline section 12. The size of opening 18 must be selected to prevent compromising the structural integrity of pipeline section 12, while still permitting the injection of the formable plugging material. There may be a source of gas connected to pressurize the hot tapping tool, which may be used to pressure test the seal of hot tapping tool 26 against pipeline section 12 prior to breaching the pipe. Once opening 18 is formed, a blast of the high pressure gas, or an alternate cleaning product may be used to clear debris from the internal portion of the pipe prior to injecting the plugging material. Preferably, the gas is inert, such as nitrogen. The cleaning product may be a degreaser, solvent, water, or other fluid as will be recognised by those skilled in the art. Next, hot tapping tool 26 is used to inject a formable plugging material through opening 18 to form a sealing plug 20 within pipeline section 12. Sealing plug 20 preferably has a length in the axial direction of between two and four feet, although it will be understood that this length may vary depending on the application. The material must be capable of being injected in a fluid or formable state, and set to a solid or plugging state in the conditions present in pipeline section 12. This may include the presence of fluids, such as water, any remaining cleaning solution, hydrocarbons in a liquid or gas phase, or solids such as sand or scale. The proper formulation for this material can be determined by a person of ordinary skill and may include various materials such as epoxy, resin, or polymer materials. Preferably, the plugging material will form a plug that is solid and not appreciably compressible. In aid of this, it is preferred to inject the plugging material in a manner that does not allow air pockets to form.

In order to ensure sealing plug 20 is stationary, an anchor is used. One example of anchoring sealing plug 20 is to form a crimp 22 in pipeline section 12 on plug 20. This may also be used to enhance the seal between plug 20 and the inner wall of pipeline 12. As shown, crimp 22 is preferably spaced toward the end of plug 20 closest to the abandoned well 16. This is because, once abandoned, plug 20 and crimp 22 must withstand the pressure from pipeline 14. Crimp 22 may be a ½ inch impression on the top and the bottom of the pipe. Alternatively, an anchor may also be formed as pipeline section 12 is breached. For example, if a piercing tool is used that breaches pipeline section 12 in response to a compressive force, pipeline section 12 will be deformed inward as the sidewall may bend slightly under the compressive force, and the sidewall material may be compressed and torn by the piercing tool as it breaches pipeline section 12. In some circumstances, this deformation may provide a sufficient anchor for plug 20.

Each of the steps described above are preferably performed from the ground level. In a preferred embodiment sealing plug 20 will be able to maintain a 450 psi pressure differential between the production side of plug 20 and the abandoned section 12 without movement of plug 20 or loss of sealing capability. This allows remaining portion 14 to continue to be operated after abandoned section 12 has been removed. Remaining portion 14 may commonly be operated at 5 psi to 120 psi, however, it is preferred that plug 20 meet the 300 ANSI (American National Standards Institute) standard as generally required by industry.

Once properly plugged, the pressure in abandoned section 12 may be released and any remaining fluid may be removed, such as through a vent 24. The actual venting and draining method will depend on the materials within pipeline section 12.

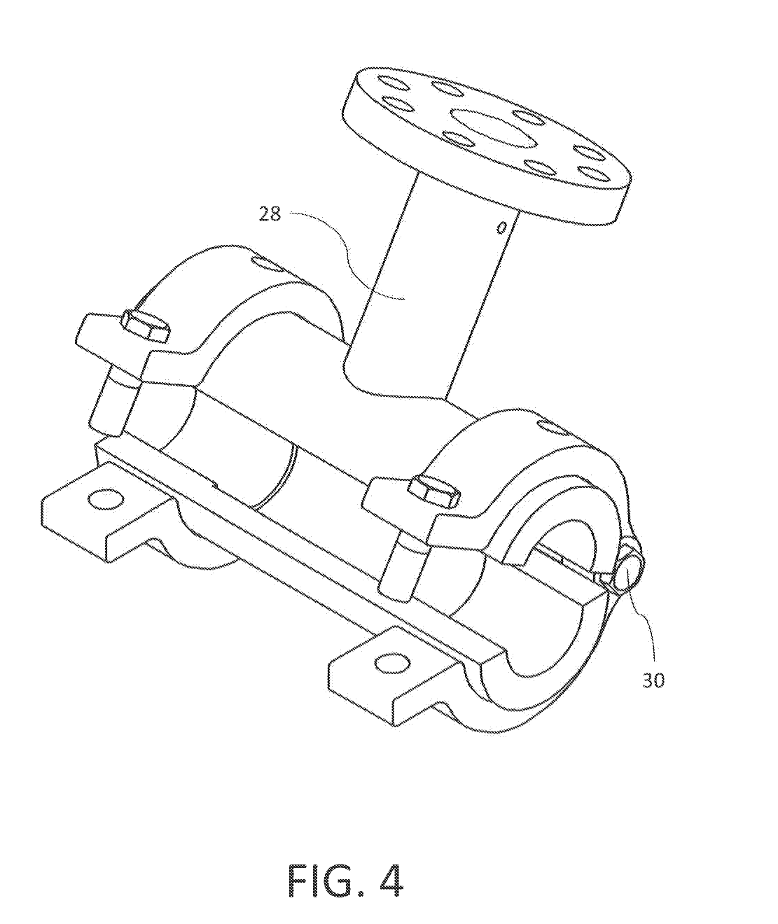

While methods of hot tapping pipelines are known in the industry, an example of a suitable hot tapping tool 26 will now be described with reference to FIG. 3. Modifications may be made by those ski lied in the art. Tool 26 is applied to the abandoned portion of the pipeline 12. In order to attach to abandoned portion 12, tool 26 has a gripping portion in the form of a split tee 28, as shown in FIG. 4. Split tee 28 is capable of opening to fit around pipeline 10, and then closing to engage pipeline 10. Split tee 28 may fit around pipeline 10 by any method known in the art, such as by using a hinged connection 30, as shown in FIG. 4, or through assembly from two portions. Referring to FIG. 5, split tee 28 has a seal 34 that engages and seals between split tee 28 and pipeline section 12 to form a chamber that is isolated from atmosphere and that will maintain the pipeline pressure once pipeline 12 has been breached. Split tee 28 has an opening 54 within the seal 34 to provide access to pipeline section 12 in order to allow it to be opened and to allow the plugging material to be injected. Referring to FIG. 3, Hot tapping tool includes a housing 36 attached to split tee 28 through which the various tools may be manipulated during the hot tapping and injection steps as will be described below. Housing 36 is connected to split tee 28 by a lower valve 38. When lower valve 38 is closed, the pressure from pipeline section 12 is isolated from atmosphere and housing 36 may be removed or attached as necessary. In one embodiment, a motor 40 and gear 42 may be provided to allow housing 36 to be easily threaded onto and off of lower valve 38. Opposite the end that attaches to valve 38, housing 36 has a seal 44, such as a packing element or other suitable seal that seals around an actuator rod 46 and maintains pressure when housing 36 is attached to valve 38 in the open position, while allowing actuator rod 46 to move axially through housing 36 and valve 38. By attaching and removing housing 36 with valve 38 in the closed position, different tools can be introduced through valve 38, as required.

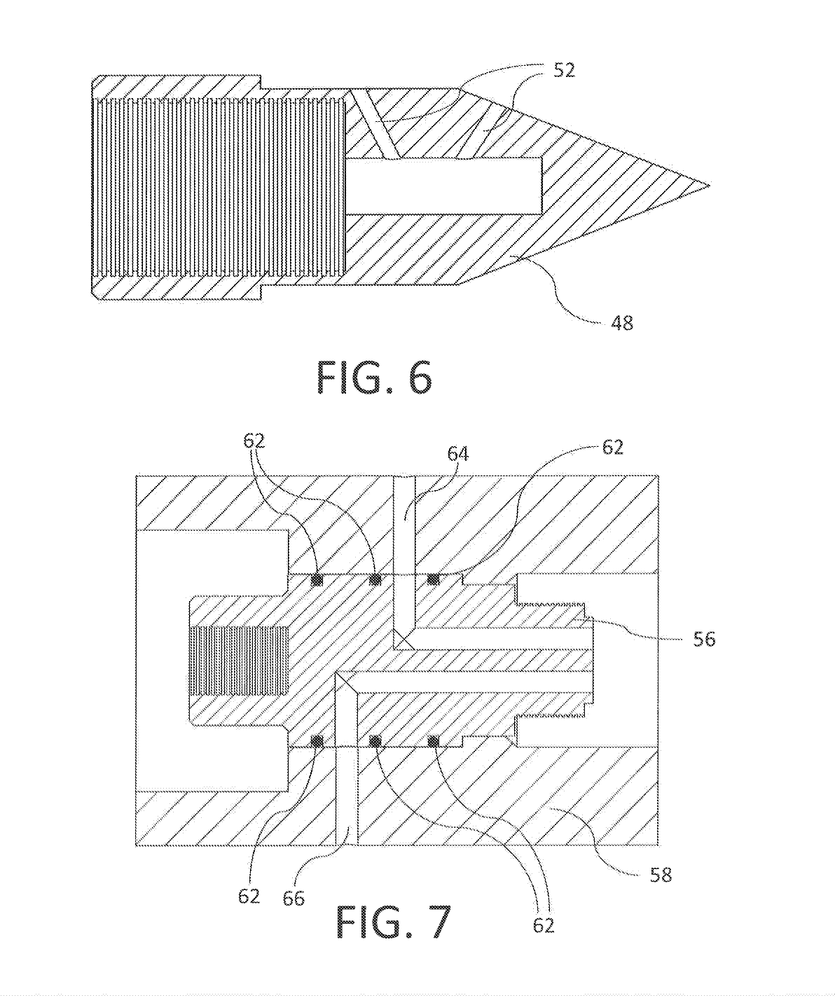

Referring to FIG. 3, with split tee 28 properly installed on pipeline section 12, a breaching tool 48 is attached to actuator rod 46 and retracted into housing 36. Housing 36 is then threaded onto split tee 28 and valve 38 is opened. Actuator rod 46 may then be lowered and manipulated to cause breaching tool 48 to breach the sidewall of pipeline section 12. As shown in FIG. 5, breaching tool 48 is preferably a piercing tool that pierces pipeline section 12 by applying a compressive force, such as by using a hydraulic press 50 as shown in FIG. 8 that is designed to be attached to housing 36 and apply a downward force on actuator rod 46. Other breaching tools 48 may also be used, such as a drill bit (not shown). As shown in FIG. 5, breaching tool 48 also preferably includes nozzles 52 that are used to inject fluids, such as an inert gas, cleaning solution, treating solution, etc. in order to clear debris, clean the inner surface, or otherwise prepare the inner surface to receive the plugging material that will be injected. This may be done simultaneously or in stages. Referring to FIG. 6, breaching tool 48 may be a piercing jet nozzle that can be used to both pierce and clean pipeline 10. The inert gas may also be used to pressure test the seal between the hot tapping tool 26 and the pipeline portion 12 prior to breaching the pipeline 12 and injecting the formable plugging material.

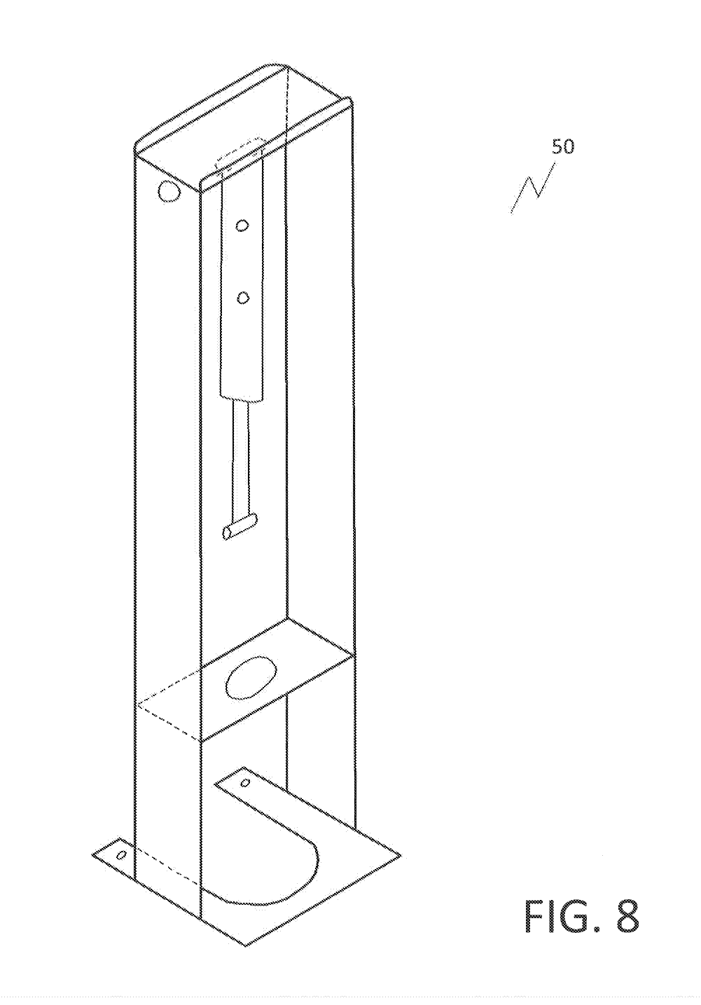

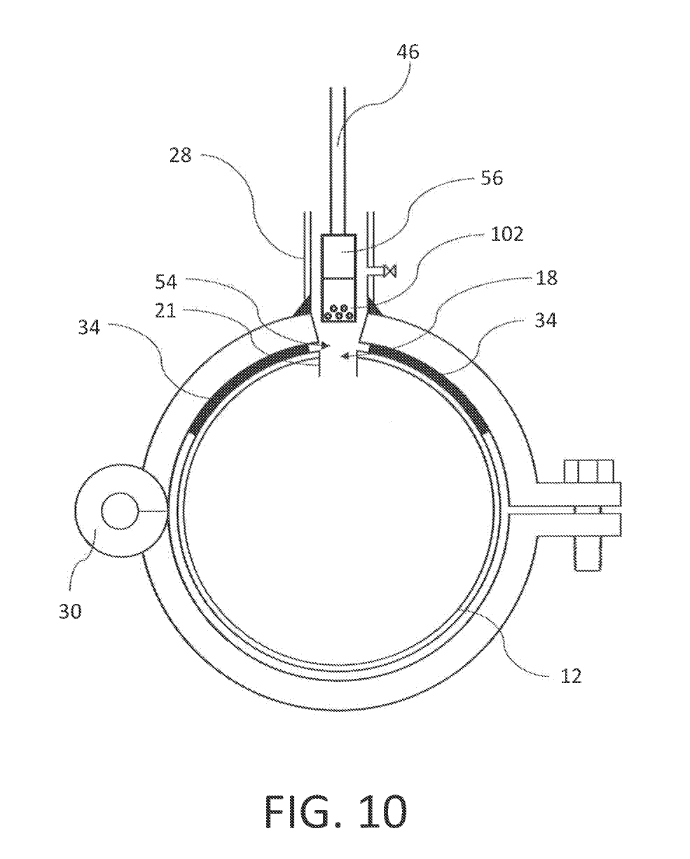

Preferably, actuator rod 46 is hollow to allow fluid to be injected through nozzles 52. Integrating these functions saves the need to attach and insert a separate cleaning tool or device. Separate tools may be used if necessary or depending on other functions that may be desired, such as an inspection camera. Once pipeline section 12 has been breached and cleaned if necessary, by piercing jet nozzle 48, tool 48 is retracted into housing 36 and valve 38 is closed. Housing 36 can then be vented and removed and an injection tool 102 (FIG. 10) may be attached to piston 56. In some circumstances, it may be necessary to use a different housing 36 or at least a different actuator rod 46, depending on the fluids being injected through rod 46. Alternatively, different injection strategies may be used with a different design of hot tapping tool 26. For example, if a two-part polymer is injected, it may be necessary to keep the components separate until they are mixed at injection tool 102. Alternatively, passage through rod 46 may form part of the mixing process. Referring to FIG. 7, a piston 56 within a cylinder 58 is shown, each of which is designed to maintain separation between two components of the sealing material. Between piston 56 and cylinder 58 seals 62 such as O-rings, are provided to maintain separation between the two components of the sealing material. Under this design, a mixing nozzle 102 (FIG. 10) will then be threaded onto the bottom of piston 56 in order to fully mix and activate the components prior to injection into pipeline section 12. The components can be injected through ports 64 and 66, which flow through to the mixing element of mixing nozzle 102 that is attached to piston 56. The amount of sealing material 20 injected should be calculated as twice the volume of pipe between main pipeline 14 and breach 18 in pipeline portion 12 to be abandoned as sealing material 20 will flow equally in either direction from the injection site. The amount of sealing material 20 should be calculated to be sufficient to fill branch 12 up to, but not into, pipeline 14, and preferably extends to within 3 inches or less of main pipeline 14, and preferably within 1 inch or less.

Referring to FIG. 1, after pipeline 12 has been plugged it may be desirable to physically isolate the remaining leg 12 or wellhead 16. Accordingly, a portion of pipeline 12 may be removed, and both ends capped with caps 60. When installing caps 60, other compounds, such as finishing, filling, or adhesive materials, may be applied, as desired.

### Operation:

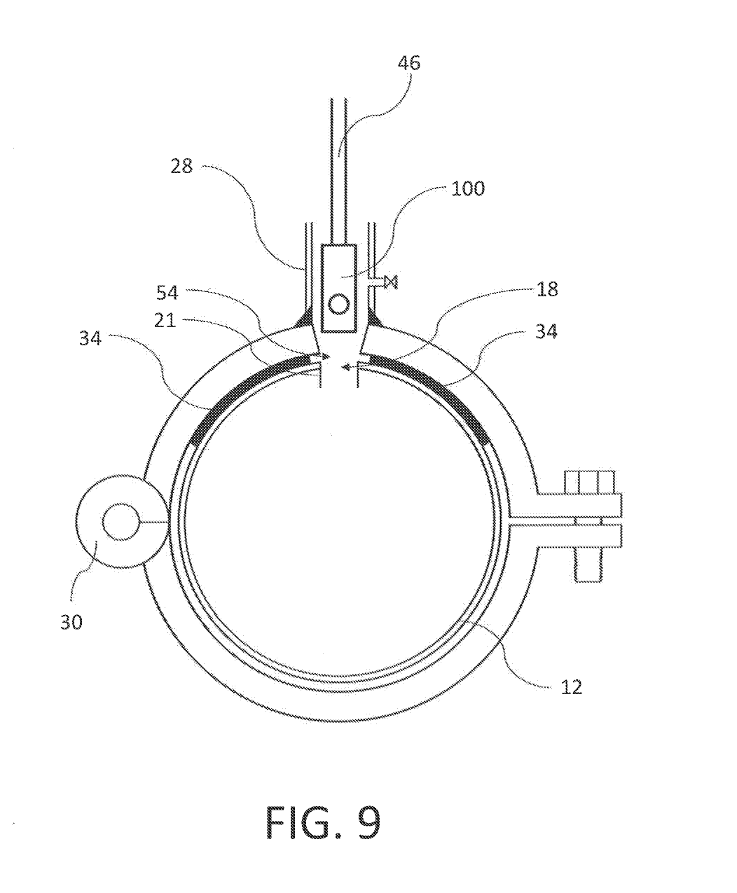

Referring to FIG. 1, when it is determined that the source 16 of material to be transported in pipeline 10 will no longer be used and it is determined that section 12 of pipeline 10 will be abandoned, it is necessary to expose pipeline 10, such as by excavating using a “hydro-vac” tool, at a point near where the abandoned portion 12 connects to the remaining portion 14, or at a convenient portion for isolating abandoned portion 12 from remaining portion 14, which will generally continue to be in use. This requires abandoned portion 12 to be plugged such that it can maintain production pressure on one side of plug 20 and ambient or atmospheric pressure on the other side of plug 20. With the exposed section of pipeline 10, the section of pipeline 10 is hot tapped in order to form an opening 18 in the section of pipeline 10 while maintaining the pressure in the section of pipeline 10. Various methods of hot tapping are known in the art and may be used. Referring to FIG. 9, it is preferred that a camera 100 is inserted into pipeline 10 in order to view the interior of pipeline 10 and determine the degree of cleaning that is required in the pipeline in order to provide a clean sealing surface. After the pipeline is breached by tool 48, tool 48 may be removed in order for camera 100 to be inserted into pipeline 10. After the degree of cleaning that is required has been determined, piercing jet nozzle 48 may then be re-inserted into pipeline 10 in order to clean pipeline 10 internally. Piercing jet nozzle 48 is connected to a source of water or solvent (not shown) and sufficient pressure is employed to dislodge debris from the interior of pipeline 10. Depending on the degree of cleaning required, it may be necessary to reinsert camera 100 and reassess the interior of pipeline 10 and provide further cleaning with piercing, jet nozzle 48.

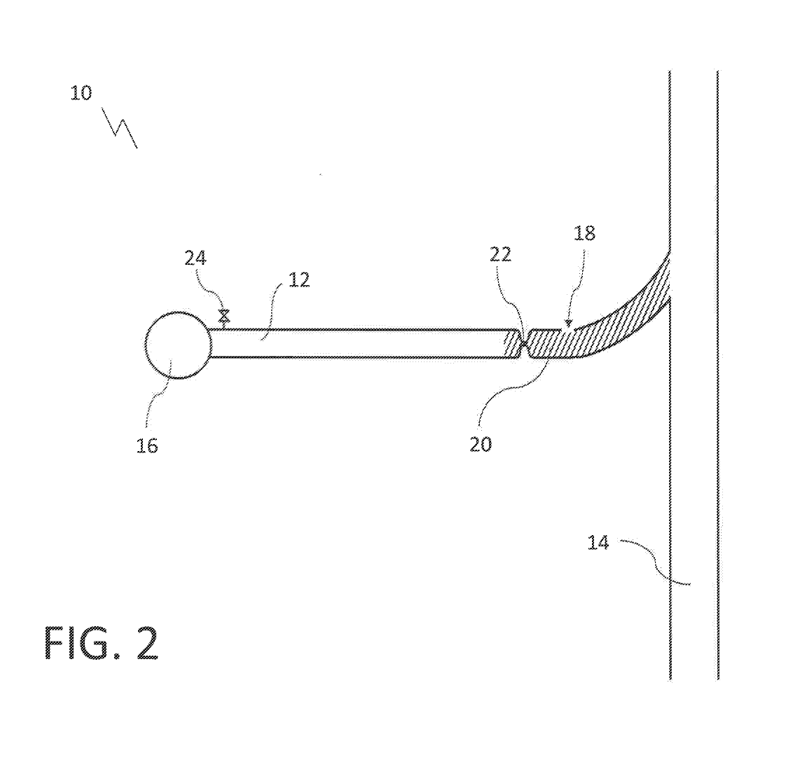

Referring to FIG. 1, after opening 18 is formed a formable plugging material such as a polymer or other appropriate material as known in the art is injected through opening 18 in order to form a sealing plug 20 between the abandoned section 12 and the remaining portion 14. Preferably, plug 20 has a length in the axial direction of two to four feet, although it will be appreciated by one skilled in the art that this length may vary depending on the application. Plug 20 is preferably anchored within pipeline section 12. An anchor 21 may be inherently formed in pipeline section 12 by the material that extends inward due to the deformation caused by breaching pipeline section 12 with piercing jet nozzle 48. Alternatively, it may be done by crimping pipeline section 12 at a point along plug 20, as shown in FIG. 2. The amount of crimping required will depend on the application and the amount of pressure plug 20 will be required to withstand. Preferably, crimp 22 is an impression on the top and the bottom of the pipeline that extends ½ inch into the interior diameter of the pipe and engages plug 20. This supports the plug by compressing the plug 20 which will enhance the seal and secure the seal within the section of pipeline 10. In a preferred embodiment the crimp 22 is made on the plug 20 near the end of plug 20 that is closer to the abandoned section 12. It will be understood by one skilled in the art that the location of the crimp 22 may vary, but is made such that the plug 20 is secured within the section of pipeline 10.

Once plug 20 is secured the pressure is released from the abandoned section 12. The pressure may be released, for example, by opening vent 24 and allowing the abandoned section 12 to equalize with atmospheric pressure. Any appropriate method of releasing the pressure and draining abandoned section 12 may be used. Abandoned section 12 may remain attached to remaining section 14 or abandoned section 12 may be severed from pipeline 10 at a point on abandoned section 12 past plug 20 after pressure is released and abandoned section 12 is drained. Plug 20 remains as part of pipeline 10 that is still in use.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A method of abandoning or isolating a section of a pipeline, the method comprising the steps of:
exposing the section of the pipeline;
hot tapping the section of the pipeline to form an opening while maintaining the pressure in the section of the pipeline;
injecting a formable plugging material through the opening to form a sealing plug in the section of the pipeline; and
releasing the pressure in the section of the pipeline.

2. The method of claim 1, wherein the plugging material is an epoxy.

3. The method of claim 1, wherein the plugging material is a resin.

4. The method of claim 1, wherein the plugging material is a polymer.

5. The method of claim 1, further comprising the step of forming an anchor in the pipeline that engages the plug to support the plug within the section of the pipeline.

6. The method of claim 5, wherein forming an anchor comprises deforming the pipeline inward while forming an opening during hot tapping.

7. The method of claim 5, wherein forming an anchor comprises crimping the pipeline on the sealing plug to enhance the seal of the sealing plug.

8. The method of claim 1, further comprising the step of inserting a cleaning nozzle to clean the pipeline internally.

9. The method of claim 1, further comprising the step of injecting an inert gas to pressure test and clear debris prior to injecting the formable plugging material.

10. The method of claim 1, wherein the pipeline has one of a 2 inch diameter, a 3 inch diameter, and a 4 inch diameter.

11. The method of claim 1, wherein the plug maintains up to a 450 psi pressure differential between a production side and an abandoned side.

12. In combination:
a hot tapping tool adapted to hot tap a section of a pipeline to form an opening while maintaining the pressure in the section of the pipeline; and
an injector adapted to inject a formable plugging material through the opening to form a sealing plug in the section of the pipeline.

13. The combination of claim 12, wherein the plugging material is an epoxy.

14. The combination of claim 12, wherein the plugging material is a resin.

15. The combination of claim 12, wherein the plugging material is a polymer.

16. The combination of claim 12, further comprising a camera for determining the degree of cleaning required in the pipeline.

17. The combination of claim 12, further comprising a jet nozzle for cleaning the pipeline internally.

18. The combination of claim 12, further comprising a source of inert gas connected to pressurize the hot tapping tool.

19. The combination of claim 12, wherein the pipeline has one of a 2 inch diameter, a 3 inch diameter, and a 4 inch diameter.

20. The combination of claim 12, further comprising tool for deforming the pipeline to form an anchor for anchoring the plug within the pipeline.

21. The combination of claim 12, further comprising a source of formable plugging material connected to the injector.

22. The combination of claim 12, further comprising a tool for cutting a segment from an abandoned section of a pipeline for terminating and detaching the abandoned section of the pipeline from a remaining section of the pipeline.
